(19) United States
(12) Patent Application Publication
(10) Pub. No.: US 2025/0045137 A1
(43) Pub. Date: Feb. 6, 2025

(54) SYNTHESIS OF TROUBLESHOOTING RESPONSE DOCUMENTATION FOR POWER GENERATION DEVICES

(71) Applicant: AES US Services, LLC, Indianapolis, IN (US)

(72) Inventors: Srikanth Tadepalli, Dayton, OH (US); Sean Otto, Indianapolis, IN (US); Guohua Ren, Indianapolis, IN (US); Matthew Myers, Bear, DE (US)

(73) Assignee: AES US Services, LLC, Indianapolis, IN (US)

(21) Appl. No.: 18/790,589

(22) Filed: Jul. 31, 2024

Related U.S. Application Data
(60) Provisional application No. 63/530,200, filed on Aug. 1, 2023.

(51) Int. Cl. G06F 11/07

(52) U.S. Cl. CPC G06F 11/0766; G06F 2201/805

(57) ABSTRACT

A system for synthesizing fault response documentation for power generation devices includes troubleshooting response synthesis circuitry configured to identify a fault stack based on monitored conditions at a first power generation device. The troubleshooting response synthesis circuitry may supplant missing documentation with documentation for power generation devices of a different type from the first power generation device. Language processing and translation is used to construct synthesized documentation for the first power generation device based on the documentation for power generation devices of a different type from the first power generation device. The synthesized documentation is used with generative language processing to generate troubleshooting response messages for faults in the identified fault stack.

### PRIORITY

This application claims the benefit of U.S. Provisional Patent Application No. 63/530,200, filed Aug. 1, 2023, and entitled SYNTHESIS OF TROUBLESHOOTING RESPONSE DOCUMENTATION FOR POWER GENERATION DEVICES, which is incorporated herein in its entirety.

### TECHNICAL FIELD

This disclosure relates to synthesis of troubleshooting response documentation for power generation devices.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

Wind turbines typically include various components, including a support tower (e.g., a mast), a nacelle (which may include any one, any combination, or all of the generator, gearbox, or drivetrain), a hub (which may include a pitch system such as a pitch motor), and blades. The pitch motor may be used to change the pitch of a blade of the wind turbine. Various parts of the wind turbine may experience light duty, normal wear, and/or intensive usage. Accordingly, wind turbines may require maintenance at different intervals due to different usage patterns different part lifetime, and different models. Similarly, other power generation devices may have components with usage-dependent and/or condition-dependent unit lifetimes may requirement maintenance. In some cases, regular maintenance may reduce unexpected power generation device failure. On the other hand, regular maintenance results in some turbines receiving otherwise unneeded upkeep and/or service instances that result in no actual repairs. Given the human danger associated with ascending a turbine, costs associated with shutting down/restarting a fuel/renewables-based generator, replacing heavy machinery, falling object risks, electrical shock, and other risks, operators are reluctant to execute maintenance that is regularly found to be unneeded. Accordingly, there is demand for techniques to accurately access the condition of turbines.

### BRIEF DESCRIPTION OF THE DRAWINGS

FIG. 1 shows an example troubleshooting response synthesis system.

FIG. 2 shows example troubleshooting response synthesis logic.

FIG. 3 shows an example synthesis computation environment.

FIG. 4 shows an illustrative example troubleshooting response synthesis system.

FIG. 5 shows example synthetic fault description generation logic.

FIG. 6 shows prompt selection logic.

### DETAILED DESCRIPTION

In various contexts, wind turbines and other power generation devices may have an expected time to failure (TTF) that may be dependent on the model of the power generation device, manufacturing quality variance, the age of the power generation device, fault history, the usage level of the power generation device, the historical operational data for the power generation device, maintenance history, and various other factors. Moreover, power generation devices may report condition indicators such as sensor data, fault codes, and/or other data indicative of current conditions. Power generation devices may include devices, such as, wind turbines, solar cells, fuel/renewables-based generators, fuel cells, reactors, and/or other power generation devices.

As used herein, a ‘fault’ may include an operational state or current condition that is outside of a normal operational tolerance for a power generation device. As used herein a ‘failure’ may include a condition that prevents acceptable operation of the power generation device. As used herein, a ‘fault stack’ may include a particular ordered collection of one or more faults. Fault stacks do not necessarily progress. As an illustrative example, a redundant sensor may fall out of tolerance creating a fault, but the redundant sensor may not necessarily affect other systems. Accordingly, one fault stack associated with the dead redundant sensor may be a non-progressing fault stack.

Various fault stacks may progress. For example, a fault stack may progress through one or more fault conditions to one or more failure conditions (although progression to a failure condition is not necessarily characteristic of all progressing fault stacks). In some cases, a progression may be effectively immediate (e.g., occurring in less than time than would be necessary to respond) in other cases a fault stack may progress over time, e.g., minutes, hours, days, months, years. Thus, an identified fault stack may provide information relevant to prediction of TTF for a power generation device. In some cases, the importance of a particular fault stack may be dependent on whether a failure state (and/or failure identifier code) is associated with the fault stack. In various implementations, a fault stack with a failure identifier may be referred to as a fault sequence.

However, various different fault stacks may include overlapping faults. For example, a non-progressing fault stack including only a malfunctioning temperature sensor may produce the same reported fault code as an over-temperature power generation device component. Thus, prediction of a particular fault stack may not be possible based only on reports of fault conditions. Historical data particularized to an individual power generation device may provide additional data on various factors discussed above allowing refinement of fault stack identification. Architectures and techniques, such as those discussed herein, the support the integration of the particularized historical data analysis into prediction of fault stacks may provide increased performance (e.g., via increased prediction accuracy)

To avoid progression to failure conditions, wind power generation devices need to be timely maintained. This may increase power generation device uptime and reduce the cost of repair/maintenance. Building models to predict TTF may provide insight into a potential failure occurrence time period. However, identifying the fault stack (and/or narrowing the space of possible fault stacks) accurately may allow for preparation of a corrective response. In particular, the prediction of a fault stack may provide a prediction of upcoming faults likely to occur. Receiving advance notice of such conditions may allow for formulation of a response.

Further complicating response formulation, documentation for faults may be incomplete. For example, troubleshooting (TS) manuals may not be available or may be incomplete for particular power generation device models. Existing documentation may be in a language not understood by the operator of a power generation device (e.g., the manual is not available in the local language where the power generation device is installed). Thus, a predicted fault (potentially with an associated fault code, that identifies the fault for troubleshooting purposes) may, in some scenarios, be insufficient to formulate a response because no instructions for response usable by the operator exist.

The techniques and architectures discussed herein identify fault stacks to provide prediction of fault conditions. The techniques and architectures discussed herein further provide synthesized documentation to support response to the predicted fault conditions.

When documentation of for a particular power generation device is incomplete documentation from other power generation device models and/or other service regions may be used as a machine-learned information basis for synthesis of documentation for the predicted fault in a form comprehensible to the operator.

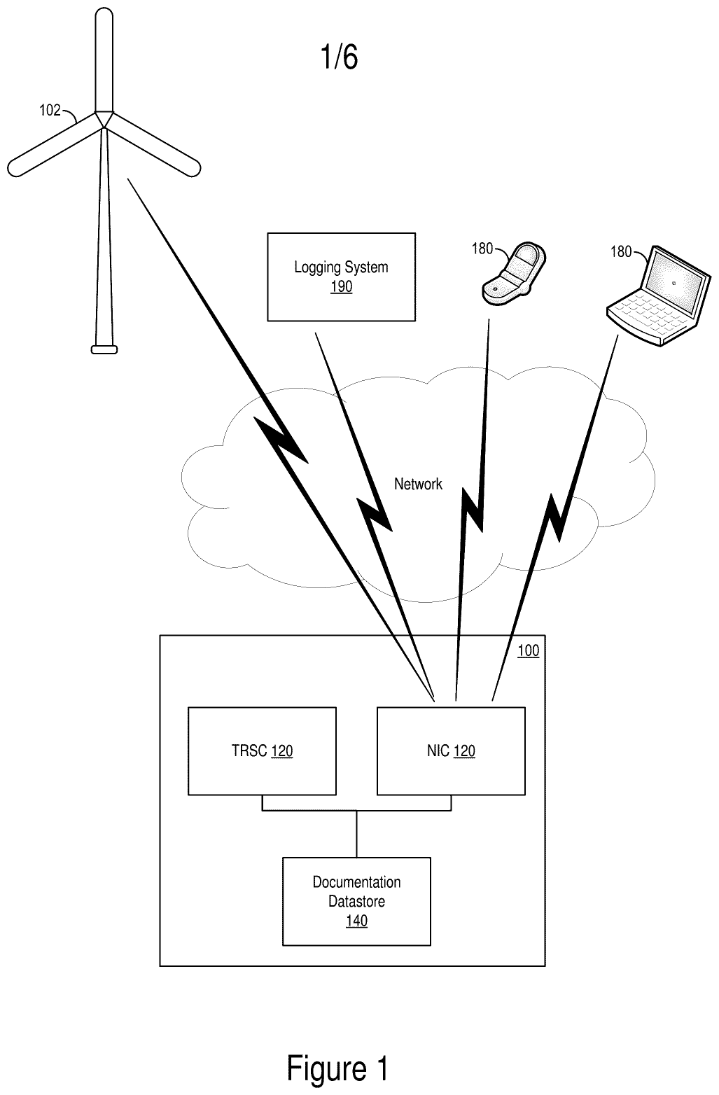

FIG. 1 shows an example troubleshooting response synthesis system (TRSS) 100. A power generation device 102 with a first power generation device type may be monitored by troubleshooting response synthesis circuitry (TRSC) 110. The TRSC 110 may be in data communication with one or more operator communication devices 180 and/or a logging system 190 via network interface circuitry (NIC) 160. In various implementations, the TRSC 110 may access a documentation datastore 140, which may include troubleshooting documentation for multiple types of power generation devices.

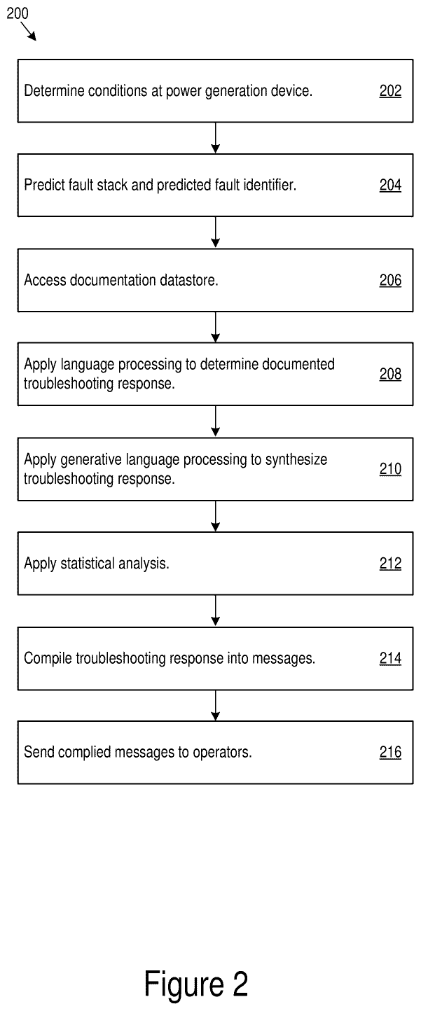

Referring now to FIG. 2 while continuing to refer to FIG. 1, troubleshooting response synthesis logic (TRSL) 200 is shown. The TRSL 200 may govern operation of the TRSS 100 and may execute on the TRSC 110 and/or NIC 160.

The TRSL 200 may determine one or more conditions, such as faults, operating parameters, fault codes, and/or other conditions, at the power generation device 102 (202). The determination may be based on data received via sensors, reports, and/or other monitoring performed on the power generation device 102.

Using a power generation device fault model and historical data particularized to the power generation device 102, the TRSL 200 may predict a fault stack and a predicted fault identifier (such as a fault code, or fault name for a predicted upcoming condition) based on the determined condition (204). The fault identifier may be associated with a naming/indication scheme for the for power generation device type (such as a model number, part number, stock keeping unit (SKU), or other classification).

The historical data particularized to the power generation device 102 may include historical data that is representative the usage pattern, model type, fault history or pattern, power consumption, power output, performance and/or other data that may be used to describe actual or probable historical outcomes specifically for the power generation device 102. The historical data may include actual historical data for the power generation device 102. For power generation devices with a recorded history, e.g., multiple months, years, or other operational history period. In various cases, the actual historical data from the power generation device may be used.

In some cases, actual historical data the power generation device 102 may not be available. For example, the power generation device 102 may have been recently installed and may not have an established operational history. For example, some portion of the power generation device's operational history may not have been recorded (or may have been lost or deleted). Hence, a suitable substitute history from one or more surrogate power generation devices may be selected.

In some cases, a substitute history may be used by the TRSL 200. For example, history from similar model power generation device with similar operational conditions may be used.

Various similarity measures may be used by the system. For example, the TRSL 200 may use a coherence value derived from performance history (e.g., power generation device power) to select a representative power generation device to be the surrogate. For example, the TRSL 200 may use a coherence value derived between consumption and supply. Such a consumption and supply based analysis may also be used in demand planning to establish a cluster of components that behave similarly. Thus, the TRSL 200 may facilitate transfer learning among the cluster of parts. The minimum and maximum values of the economic order quantity (EOQ) of a SKU with limited history may be approximated based on the average of min and max values of the surrogate SKUs. In an example, the TRSL 200 may derive a coherence value for current consumption (e.g., for a current time window) based on past consumption (e.g., from a past time window). The past time window may operate as a Motif window. As a result, the safety stock value from the Motif window may be used as the required safety stock value in the current time window.

In some cases, a coherence analysis may produce multiple suitable surrogate candidates. In some cases, a priority scheme for surrogate selection may be determined. For example, the surrogate candidates may first be ranked according to the coherence value. Nevertheless, coherence value ranking may lead to some candidates that are equally ranked. Thus, after sorting according to the coherence value, candidates may be ranked according to age index, of which those with the smallest age index difference may be ranked highest. After age index, model/design type (which may be similar across manufacturers) may be used. Manufacturer may be used when other factors do not distinguish candidates. However, other factor priority schemes may be used. For example model similarity may be applied ahead of age index. For example, one of the listed factors may not be considered in a particular priority scheme.

In various implementations, various similarity metrics may be used to rank candidates (in this and/or other semantic/syntactic ranking contexts). For example one or more dimensional analysis may be used. In some implementations, coherence (e.g., relevance), information potential, and/or entropy (e.g., summary/emotion) may be used alone or in combination as evaluation dimensions to provide for candidate selection and/or ranking.

In various implementations, if surrogates are not found via coherence ranking, cosine similarity measurements may be used to evaluate match among documentation to select a surrogate troubleshooting guide for the fault without necessarily selecting a surrogate history for the power generation device. For example, an above threshold cosine similarity for the fault description may be used to select a guide for the fault. In some cases, summary and emotion similarity values for the guide may be used to confirm that the selected guide is appropriate. In some cases, a threshold may be used for the summary and emotion similarity analysis. In some cases, the threshold level for the summary/emotion match may be different from the threshold used for fault description similarity. For example, the fault description similarity threshold may be 70% (in an illustrative scenario) and the summary/emotion match may be 80%. In some cases, the enforcement of the threshold may be different for example, the fault description match may be a hard threshold, below which candidates are rejected. In some cases, because the summary/emotion match may be used to confirm a guide that already met the conditions for fault description match, the threshold may be a soft threshold. In some cases, a below threshold summary/emotion match may be used. For example, the combination of fault description similarity and summary/emotion match may be compared among multiple selections to avoid selecting a guide with an inferior overall match because of a slightly below threshold match for a guide with superior fault description match.

In some implementations, appropriateness may be used as a filtering layer. For example, a set of top candidates may be selected. Then, among the selected candidates, weak (e.g., via absolute metrics), and/or relatively weak (e.g., compared to other top candidates) ones of the selected candidates may be filtered. Thus, a filtered selection may include the top semantically/syntactically similar candidate with the highest summary/emotion and/or summary/emotion with strong matching. Negative filtering may, in some cases, go beyond filtering “inappropriate” summary/emotion matches to filtering appropriate but “weak” summary/emotion matches. In some cases, such filtering may ensure an increased level of binary summary/emotion application, where summary/emotion is strongly matched or the candidate is rejected.

In various implementation, entropy and information potential for the candidates is calculated. In some implementations, the entropy and information potential may be calculated for a select number of candidates, such as a group of top candidates based on coherence and/or summary/emotion. The entropy and information computation may be independent of the input fault/fault stack. The entropy and information potential computation may instead be based on the uncertainty/information tradeoff in a particular corpus (for example, the selected top candidates may serve as such a corpus).

In some implementations, Shannon entropy may be used. For example, the probability distributions for all semantic tokens in the candidate corpus may be computed. Then (for a given candidate strategy), we calculate the sum of these probabilities based on that distribution. This may provide an indication of the extent to which there is relative uncertainty in the strategy.

Information potential may be calculated as a series of NLP metrics related to length and unique tokens. This computation may provide a measure of how much potential there is for new information to exist in the candidate strategy.

The various similarity metrics coherence, information potential, entropy, summary/emotion, and/or other semantic/syntactic metrics may be used individually and/or combined into various composite similarity metric with multiple metrics each serving as a dimension of the composite metric.

Prediction of the fault stack and/or fault identifier may include the TRSL 200 using a machine-learned and/or analytic analysis to determine a signature and prediction from events within time series data from power generation device condition monitoring. Fault stacks matching the signature may be identified. Faults from progressions (e.g., time series data including the faults) from the signature-identified fault stacks may be provided as the predicted faults. The fault identifiers for this analytic analysis may then be processed for troubleshooting documentation synthesis.

In various implementations a long short-term memory (LSTM) network may be used to provide the forecast for the fault stack. In some cases, the signature from the chain of faults may be determined using a sequence miner and sequence generator the builds a fault model from history, a corpus of data obtained from analyzed troubleshooting materials, and/or other information sources.

To determine a troubleshooting response for the predicted fault identifier, the TRSL 200 access the documentation datastore 140 (206). In some cases, the predicted fault may have robust documentation specific to the power generation device 102 in the desired language present within the documentation datastore 140. Accordingly, documentation may in some instances be found by preforming a lookup operation on the predicted fault identifier. In some cases, robust information may exist as a result of an intake language model analysis that incidentally includes the relevant troubleshooting information. In some cases, robust documentation may exist as result of previous application of the translation, natural language processing (NLP), and large language model (LLM) processing described herein. Once documentation has been synthesized, the results may be indexed and reused for reoccurrences of the same fault identifier.

Nevertheless, in some cases, documentation in the appropriate form may not exist. The TRSL 200 may apply language processing (such as translation, NLP, and/or other processing) to the documentation datastore 140 determine a documented troubleshooting response for a fault that corresponds to the predicted fault (208). For example, the predicted fault and the documented fault may have overlapping narrative-type (natural language) descriptions. The predicted fault and the documented fault may have similar names. LLM processing may be used to determine similarity in names, descriptions, and/or codes. Other similarities may be used.

In some cases, input faults lack any available description. Where no description is available, a numeric approach to generation relevance/coherence metrics may be applied.

In some implementations, the fault code schemes used for the power generation device type of the power generation device 102 may have established analogs. For example, the documentation datastore 140 may be indexed into asset maps, such that multiple fault code schemes for multiple different power generation device types are organized into analogs. Accordingly, for any given fault, the documentation datastore 140 may index corresponding fault codes for multiple manufacturers/models/time periods. Accordingly, documentation for the same fault in different power generation devices may be grouped together. The indexing may be facilitated using LLM processing.

Once troubleshooting documentation for an at least analogous fault to predicted fault has been obtained/translated by the TRSL 200, the TRSL 200 may apply generative language processing using the documented troubleshooting response to generate a synthesized troubleshooting response including a natural language description of an action particularized to at least the first power generation device type (210).

Because the documentation may not necessarily be for the type of the power generation device 102, the documented response may correspond in qualitative substance (e.g., the type of repair/remediation may be the same) but the practical implementation may have some or no correspondence. For example, sensors with the same functional purpose may be in entirely different location on different power generation devices. Controls may be located differently and accept different input formats. Accordingly, the generative analysis cannot reliably extract existing text from the documented response and recompile that same text for a response to the predicted fault in the power generation device 102. The generative language processing may determine “what” from the existing documentation for the documented fault. Then, generative language processing (in some implementation, separate generative language processes) may determine “how” the determined “what” for the power generation device 102 specifically. Accordingly, the generative language processing may implement analysis on both the fault documentation and operation documentation for the power generation device. In some cases, the analyses may rely on disparate sources for these different facets of the generative language analysis.

In various implementations, the generative language analysis may include a large language model (such as a deep learning network or other machine-learned model). For example, a chatGPT (Generative Pre-trained Transformer) type system may be implemented. The use of large language models may support the synthesis of troubleshooting documentation with clearly identified and comprehensible response steps. Clarity with regard to how actions are to be performed may increase usability and user experience for the system. Accordingly, the generative language systems may be used to increase clarity even in situations where usable but low detail/clarity documentation is present within the datastore. For example, existing documentation may include a maze of internal references (e.g., “see page X for replacement process”), tables of error codes, references to other documentation, and/or other clarity issues that may limit usefulness of such documentation or increase time taken to determine the appropriate corrective action. The large language model processing herein may additionally or alternatively be used to present information from existing documentation synthesized in a clear and concise form, in which irrelevant information may be excluded.

The troubleshooting documentation synthesis may be repeated (or executed in parallel) for other predicted faults. The other predicted faults may include faults from different fault stacks (e.g., probabilistic alternatives) and/or faults from the same predicted fault stack (e.g., faults that may occur along with the predicted fault). Thus, multiple different troubleshooting responses may be generated.

The TRSL 200 may apply statistical analyses to the different faults to determine notification priorities for the synthesized responses (212). For example, faults associated with failure probabilities below a determined threshold may be given a lower priority than those associated with above-threshold failure probabilities. Response may be sequenced for corrective action in accord with probability of failure, probability of non-failure degraded performance, and/or other concerns. In some cases, message handling may be based on such probabilities. For example, faults associated with failure probabilities below a determined threshold may be added to a logger and no action may be recommended. Alternatively or additionally, an action may be added to a queue of repairs/maintenance. Faults associated with failure probabilities above a determined threshold may generate alerts directly and/or immediately provided to operators. Actions may be inserted into repair queues at priority locations to ensure prompt response. Logging and other data retention may still be executed along with the prioritized actions. In some cases, the TRSL 200 may group repairs such that lower priority repairs get promoted to be scheduled along with newly scheduled high priority repairs on the same power generation device, this may reduce service instances.

The synthesized troubleshooting response may be compiled into various messages (214) for the statistically determined actions. For example, the synthesized troubleshooting response incorporated into alert messages, emails, and/or logs to support notifications. A generative LLM may be used to support the compilation of particular messages types based on the synthesized troubleshooting response.

After generation of the messages based on the synthesized troubleshooting response, the TRSL 200 may send, via network interface circuitry, the troubleshooting messages to the determined response destinations (e.g., logs, alerts, emails) (216).

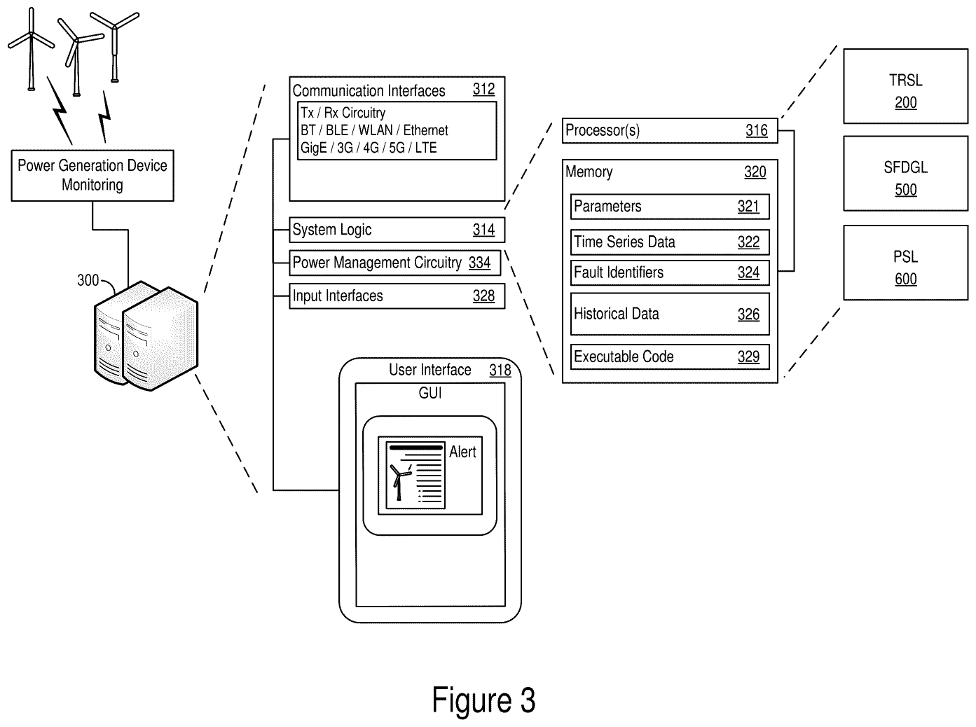

FIG. 3 shows an example synthesis computation environment (SCE) 300, which, for example, may operate as the TRSC 110 and/or NIC 160. The SCE 300 may include system logic 314 to support implementation of the example TRSL 200. In some contexts, the SCE may provide a computation environment for the synthetic fault description generation logic 500 and/or prompt selection logic 600 described below. The system logic 314 may include processors 316, memory 320, and/or other circuitry, which may be used to implement the power generation device monitoring, fault stack prediction, documentation asset mapping, documentation translation, LLM analyses, statistical analyses and/or perform other documentation synthesis operations.

The memory 320 may be used to store: time series data 322, fault identifiers 324, and/or historical data 326 used in fault analysis and documentation synthesis. The memory 320 may further store parameters 321, such as machine-learned network states, parameters for analytic analyses, LLM parameters and/or other synthesis parameters. The memory may further store executable code 329, which may support input data handling, machine-learned network operation and/or other synthesis functions.

The SCE 300 may also include one or more communication interfaces 312 which may operate as the NIC 160 in various implementations. The one or more communication interfaces 312 may support wireless, e.g. Bluetooth, Bluetooth Low Energy, Wi-Fi, WLAN, cellular (3G, 4G, 5G, LTE/A), and/or wired, ethernet, Gigabit ethernet, optical networking protocols. The SCE 300 may include power management circuitry 334 and one or more input interfaces 328.

The SCE 300 may also include a user interface 318 that may include man-machine interfaces and/or graphical user interfaces (GUI). The GUI may be used to present details of identified faults and fault stacks, synthesized documentation, and/or other information.

The SCE 300 may be implemented as a localized system, in some implementations. In some implementations, the SCE 300 may be implemented as a distributed system. For example, the SCE 300 may be deployed in a cloud computing environment (such as serverless and/or server-centric computing environments). In some cases, the SCE 300 may be implemented (at least in part) on hardware integrated (and/or co-located) with a user terminal.

### Example Implementations

Various example implementations are described below. The example implementations are illustrative of the various general architectures described above. The various specific features of the illustrative example implementations may be readily used in other implementations with or without the various other specific features of the implementation in which they are described.

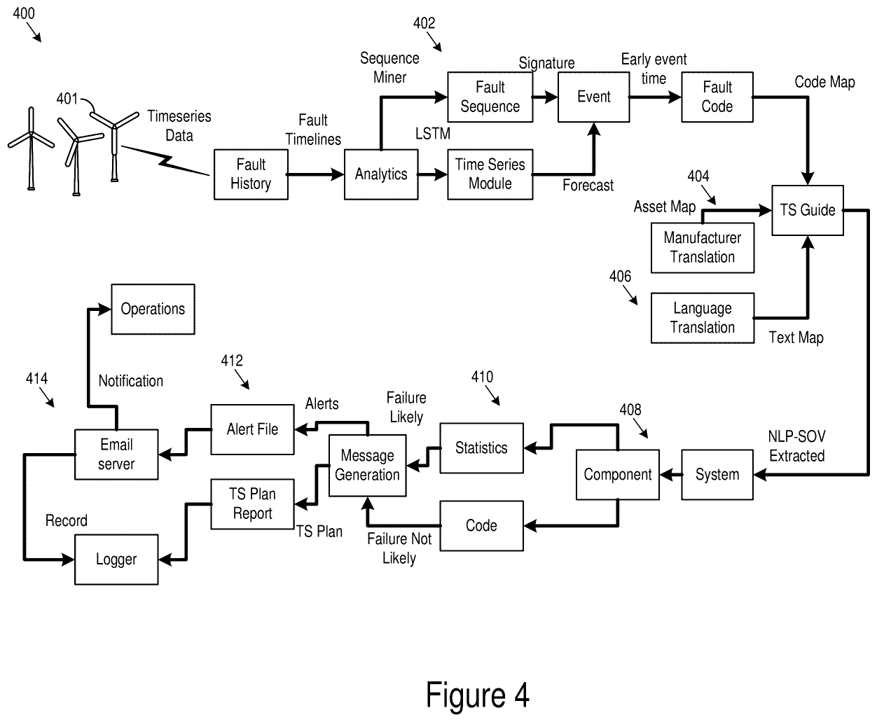

In an illustrative example documentation synthesis system 400 shown in FIG. 4, a LSTM based sequence predictor (or fault stack predictor) is used to predict a fault stack (e.g., providing a signature for a particular failure) in addition to predicting a TTF (402). The example documentation synthesis system 400 is shown in the illustrative context of a wind turbine power generation device. However, other example systems may be applied to other power generation devices such as solar cells, fuel/renewables-based generators, fuel cells, reactors, and/or other power generation devices. The prediction may be based on current condition monitoring at the turbine of interest 401 and historical data for the turbine 401.

In various implementations, a model of TTF may be used. For example, the reported TTF may be a highest probability (modal) TTF for a particular failure identifier. In some cases, a mean TTF and median TTF for statistical data on the failure identifier may be reported. Other TTF models may be used.

For various failure identifiers estimated downtime (EDT) may be reported. For example, an EDT range may be reported. For example, for a data set on failures matching the relevant failure identifiers, the reported range may be a minimum downtime up to a maximum downtime. Other models may be used. For example, one or more standard deviations may be reported as the EDT range. In some cases, a single value may be reported. For example, a mean, mode, and/or median downtime may be reported. In some cases, a range (min/max, standard deviation) and a mean/mode/median may be reported to provide additional data on the spectrum of downtimes associated with a failure identifier.

The sequence miner may use association rules mining to generate primary sequences. With regard to identifying a sequence (as opposed to a coincidental progression of events) a threshold of 70% for confidence that a first event will be followed by one or more secondary events and 50% for support (e.g., a frequency among the data collected). The sequence miner may generate super-sequences and sub-sequences based on the set of primary sequences. The sequence miner may rank and sort each sequence based on a Lift score to generate final sequences of interest. A threshold for Lift, such as 150%, may be used to isolate the best final sequences. The sequence miner may enhance the primary fault sequence and all other secondary sequences (above a certain probability threshold) with sub-sequences and super-sequences to create a signature landscape. In some cases, the data frame may be completed with duration information (e.g., how long a secondary conditions persists to be counted) and TS guide availability.

In various implementations, sub-sequences may have various characteristics. For example, any extracted/extractable sub-sequence may preserve a trigger order, a consequence, and/or historical grounding from the super-sequence from which it was extracted. In some cases, sub-sequences not maintaining one or more of the characteristics may be invalid.

In some case, the sequence miner may use a pre-defined fault stack definition, e.g., to filter for fault stacks of interest. As an example fault stack definition, the first fault is constrained to faults that result in secondary, tertiary, and/or other subsequent faults (collectively one or more secondary faults). All secondary faults may occur after the first fault, but the secondary faults may happen simultaneously, in sequence, or in a stochastic order. A definition-compliant fault stack may imply a density of occurrence results in a prolonged duration. In other words, if Y (T) has happened X units of time after Z (T) then Y_Z is a fault stack. However, in various cases, other fault definition may be used by the system 400.

For the LSTM operations, the lookback sequence length may be selected to be equal to the shortest sequence in the training space. The prediction length may be selected to be that of the longest sequence in the training space. For the loss function applied for the LSTM, the system may minimize cross entropy (good learning) and maximize cosine similarity (good prediction). In some cases, regularizers may be used to avoid overfit. The LSTM may be used to the TTF and one or more most likely fault stacks. In some implementations, training sequences for the LSTM may be, at least in part, mined from sequence model and/or synthesized to create super-sequences.

Language processing and translation is used to establish similarity between predicted fault codes with other fault codes (e.g., across turbine types). Thus, where troubleshooting guide are absent for the turbine in question, the asset map may be used to provide substitute documentation (404). The NLP system may use an asset map and a linguistic translator. The system may extract SOV (subject-object-verb) groups from existing guides.

In some cases, the SOV identifications may focus on SOVs indicating system, component, and failure mode for different permutations and combinations of fault codes. The system may qualify each permutation and combination in an Act and ReAct mode with supporting statistics and failure mode relevance. In an Act step, the system may receive and process an SOV, then in multiple ReAct steps, the system may enrich SOV with processing “thoughts” about result of previous rounds. The enrichment may include linguistic enrichment (e.g., via LLM processing) and/or content enrichment via access and retrieval from external knowledge stores (e.g., external to the LLM processor, but not necessarily external to the NLP system). The system may create an additional corpus from the main corpus using synonyms. Accordingly, any target word may appear as a synonym in another guide. Qualification of faults may pivot on verbs (the search may center on verbs as a starting point). For example, the verb must carry negative polarity (e.g., the effect on the component should be an undesirable effect for the description within the guide to be considered a fault). The system may use a search radius around the pivot verb that is expected to yield the relevant noun, which may include a singular noun, a proper nouns and/or a plural noun. The system may Iterate with adjectives, if extracted verb list is empty and/or to supplement a successful verb search. For example, a search for “the component is burned” (adjective form of “burn”) after search for “the system burns” (verb form of burn) returns as empty (or to supplement successful search).

The illustrative example documentation synthesis system 400 uses a LLM based module to linguistically translate trouble shooting guides for use with the turbine of interest (406). Documentation may be translated from that published for other turbines to build a primary corpus for the turbine in question. The similarity analysis may be based on the similar fault code indices. The system 400 may use ‘langdetect’ and ‘googletrans’ and/or other similar processes for language detection and translation. Languages may include, for example, English, Spanish, Japanese, Chinese, Korean, Russian, German, French, Portuguese, Arabic, Hindi, Korean, and/or virtually any other language. The system 400 may use the LSTM predicted fault code as the input to the LLM transformer object. The system 400 may use bag of words or lexicon to build text blocks. A text block may be built for each section of interest in a troubleshooting guide. In the system 400 the LLM transformer may be trained for each block. The system 400 may use an auto-tokenizer and predictor to predict the field of interest.

A second LLM module may be used by the system 400 recommend trouble shooting steps to restore the primary device (408). The second LLM module may employ transformer objects using GPT-2 to auto-generate a troubleshooting plan. This enhanced NLP intelligence may facilitate maintenance scheduling even when a historical plan is non-existent. The second LLM may use manufacturer-to-manufacturer fault code translations extract from an analogous troubleshooting guide if the specific troubleshooting guide for the turbine of interest is not available. The system 400 may build a cascading knowledge architecture (e.g., within a document datastore) using the LLM analyses where each prediction stage feeds into the next learning step. In some cases the system 400 may be robust against linguistic challenges due to the use of section-tagged code, language detection and translation. The system 400 may implement the manufacturer-to-manufacturer fault code translations to migrate available documentation to turbines for which documentation is unavailable.

The generated text may incorporate custom metrics of loss. For example, a loss metric for translation captured via information loss (e.g., to account for possible translation errors) and/or loss metric for similarity captured via cosine similarity (e.g., to account for possible mismatch in error codes between turbine types-which may have been used to numerically justify a recommendation of a particular troubleshooting plan. In some cases, the LLM may incorporate language processing techniques such as, Act and ReAct, to address incomplete and incoherent interpretation. As discussed above, with regard to SOV processing for asset generation, the system 400 may use Act steps to initiate SOV processing and ReAct steps to refine the initial SOV outputs to create a global corpus of terms and guide assets. In some cases, a mismatch target threshold may be used for the respective Act and ReAct steps. For Act steps, a mismatch analysis for translation information loss may be used. In some cases, a hard minimum threshold may be used translation information loss. For example, translation information loss may lead to incorrection action as opposed to increased time in comprehending the intended action. For ReAct steps, the system 400 reduces context mismatch to a target. For ReAct steps a soft minimum threshold “target” may be used. Nevertheless, even below the target, a context mismatch may be preferable to no guidance. Accordingly, ReAct steps may be repeated until a target is reached. However, if the target is not met before convergence at a low match, the output complete sentence may be used rather than rejected. In other words steps will be run to meet the target match, but if matching at the target is unachievable, the output may still be used. In various implementations, the mismatch may be characterized via cosine similarity. As broadly with any feature discussed in the context of the illustrative example system 400, the Act and ReAct processing may be implemented in virtually any other implementation discussed herein with or without others of the features of the illustrative example system 400.

The system 400 may use analysis of historical statistical information to support recommendations (410).

In some cases, the system may use a third LLM module to act as the communication handler (412). A specific communication handler may better structure the predictive model from an explainability and interpretability standpoint. To support recombination of generated language for specific communications, the system 400 may rely on the parseability of a ML model and Python code by the LLM. The parse may have a syntactical and linguistical nature. The parsed knowledge may be reduced to part-of-speech taggers. The LLM module may build equivalent language constructs from the taggers. From the constructs, full and complete sentence structures may be formed by the LLM. The formed sentences may be compared against model parameters and the utility of the sentences may be confirmed for communication. In some cases, the system may employ split testing (e.g., A/B testing) to obtain data on communication utility. The system 400 may further include an information module to present instructions to the planning/reliability/operations team (414). In some cases, the generated message may be made available in multiple languages and/or adhere to a pre-determine language preference for an individual operator. In other words, an operator may request to receive messages in Spanish. Accordingly, messages may be translated/generated in Spanish for that operator and contain no content in other languages. In some cases, an operator may select multiple languages as acceptable. When multiple languages are available, the system 400 may send the message with the lowest translation information loss and best cosine similarity among the allowed languages. The generated message may be sent to a logger.

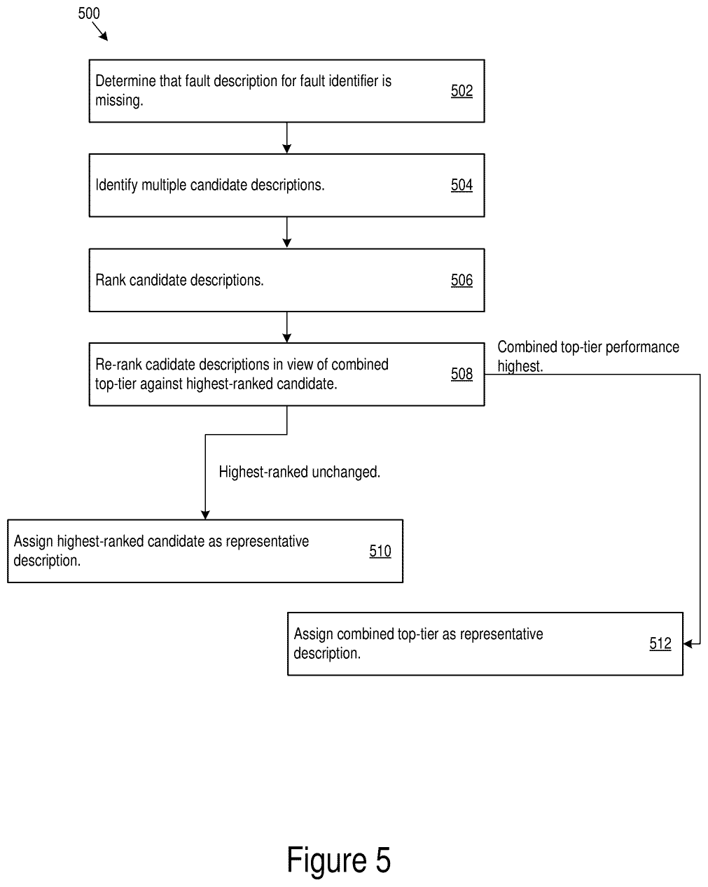

Additionally or alternatively, other techniques may be used to generate synthetic text for fault description and/or troubleshooting responses. FIG. 5 shows example synthetic fault description generation logic (SFDGL) 500, which may be generated on circuitry such as troubleshooting response synthesis circuitry 200 and/or other circuitry. The SFDGL 500 may determine to generate a fault description for a fault code (or other fault identifier) when the logic determines that a documented fault description for the first fault identifier for a power generation device is not present within the relevant datastore of troubleshooting documentation (502). The determination to generate the fault description may be performed on-demand (e.g., upon a first occurrence of the fault code) and/or based on a preemptive search for missing fault code descriptions. In some cases, a catalog of possible fault codes may be missing along with the descriptions. Accordingly, in some cases, pre-emptive fault description generation may be unavailable because the possibility of any particular fault code occurring may be unknown until the fault code occurs.

To generate the fault description, the SFDGL 500 may obtain fault descriptions for the relevant power generation device, but for fault identifiers other than the one for which the description is missing (502). Thus, the starting point for synthesis of a new fault descriptor may be existing descriptors for the same device. The existing descriptions may include neighboring description, e.g., in fault code number, fault code hierarchy, fault description memory storage order or other ordering. The existing descriptions may be selected based on syntactic closeness to anomalous status readings or other indication present at the time of fault code issuance. Additional or alternative, other criteria for proxy description selection may be used. Where a particular device has no fault code descriptions, the techniques described for selection of a surrogate device may be used. Thus, a power generation device may have at least some fault descriptions, as a starting point.

The surrogate descriptions (or other proxy descriptions) may be used to identify (504) and rank (506) multiple candidate fault descriptions, e.g. from other power generations devices. For example, the SFDGL 500 may implement a language model, such as an LLM, to identify from, e.g., the datastore of troubleshooting documentation, multiple candidate fault descriptions associated with one or more second fault identifiers different from the first fault identifier. For example, the descriptions may be associated with power generation devices different from the power generation device for which the description is missing. The identification may be based on reuse of fault code (identifier) numbering schemes, translation of fault description from alternative languages, syntactic relation to proxy descriptions for the fault code, and/or other similarity indicators.

The multiple candidate fault descriptions may be ranked using various measures to determine syntactic/semantic proximity and/or performance indications for the candidates. Thus, NLP may be used, in various implementations, to determine a highest ranked candidate and multiple top-tier candidates ranked below the highest ranked candidate, but above other identified candidates (if present). The number of candidates in the top-tier may be based on various criteria. For example, the number may be specified, e.g., hardcoded, specified by default, specified by a user, and/or otherwise specified. In some implementations, the number may be determined by the number of candidates meeting a threshold. For example, threshold values and/or value relative to that of the other candidates for entropy, syntactic closeness, lift, polarity, and/or other metrics may be used to determine the number of qualifying top-tier candidates. In some implementations, a minimum and/or maximum number of top-tier candidates may be defined and the number of candidates in various instances may float above/below/between the maximum and/or minimum based on thresholds and/or other criteria.

In various implementations, NLP clustering may be used to select the multiple top-tier candidates. For example, clustering may be used to identify a group of candidates pooled near one another and/or the highest ranked candidate.

In various implementations, a final list of candidates available for final selection and synthesis may selected according to an optimized algorithm that maximizes the “winner(s)” relevance and information potential while minimizing their combined entropy (i.e., uncertainty). Various optimization constraints allow for single and/or multiple candidate selection.

The SFDGL 500 may re-rank the candidates by comparing the highest-ranked candidate against the combined group of top-tier candidates (508). Thus, the re-ranking may involve evaluating the highest-ranked candidate against a multiple candidates together instead of individual candidates. Where the highest-ranked candidate still out-performs the combined group, the SFDGL 500 may assign the highest-ranked candidate as the new representative description for the fault code (510). Where the combined group out-performs the highest-ranked candidate, the SFDGL 500 may designate the group of top-tier candidates to serve as the new representative description for the fault code (512). Nevertheless, in some implementations, the highest-ranked candidate may be included in the group of top-tier candidates. Thus, a complete top-candidate synthesized group may be evaluated and/or ranked against the highest-ranked candidate alone and/or another synthesized group (e.g., without the highest-ranked candidate (or various other candidates) included).

In scenarios with equally performing highest-ranked candidates and top-tier candidates, a Nash Equilibrium (NE) may be determined to allow for selection among pure equilibrium and mixed-candidate strategies. When a pure equilibrium is a found, a single candidate (highest-ranked) strategy may be employed. When pure equilibrium cannot be obtained, a mixed-candidate strategy may be used. For various implementations, entropy computation may supplant NE analysis for the purposes of final candidate generation.

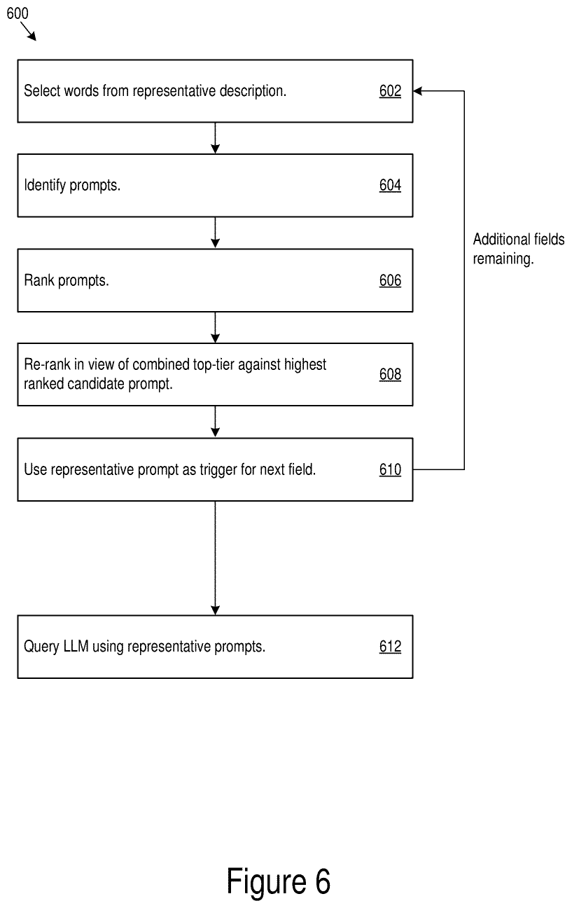

In some scenarios, whether or not a fault description is present, a troubleshooting response for the fault may be missing. To provide the missing troubleshooting response, a language model may be queried using prompts to generate the fields for the troubleshooting response. In some cases, the selection of the prompts may be used to ensure that the fields within the troubleshooting response are internally consistent/coherent and, at least when viewed as a whole, lack vagueness with regard to the nature of the fault and the corresponding steps to be taken in response to the fault. In various implementations, prompt selection logic (PSL) 600, shown in FIG. 6, may be used to generate troubleshooting response fields (including fault description fields, e.g., where a proxy description is unsuitable for direct application as a replacement fault description. For example, a proxy description selected using the SFDGL 500 may include reference to items and/or fault codes that do not correspond to counterparts for the power generation device to which the proxy description assigned, the representative description may be in a language other than the desired language, the proxy description may be multiple combined descriptions (e.g., where the top-tier candidates are used as a group), and/or otherwise be insufficient for use as a user-level description.

For a given first field of a troubleshooting response, the PSL 600 may, based on a fault description and/or a representative description for the fault, use semantic/syntactic analysis (e.g., NLP), to select one or more words from the description and form a candidate prompt (602). The PSL 600 may repeat the process to generate multiple candidate prompts. The generated multiple candidate prompts for the first field may then be ranked (604). For example, various similarity and/or consistency measures with existing description (e.g., for other faults for the power generation device) may be used to evaluate the candidate prompts for performance. Thus, NLP may be used in the design process for the candidate prompts. Then, from the multiple prompts a highest ranked prompt and a top-tier of prompts are selected (606). In some cases, the multiple prompts may be generated such that the resultant prompts include only the highest ranked prompt and the top-tier. Thus, the designation of a prompt as a top-tier does not necessarily imply that other lower-tier prompts are generated by the PSL 600. Nevertheless, in some implementations, the PSL 600 may generate at least a prompt that is neither a top-tier prompt nor the highest ranked prompt, e.g., to ensure that the generation of prompts that could qualify for the top tier has been exhausted and/or that other unidentified higher ranking prompts cannot still be generated, e.g., after a minimum number of prompts are generated.

The PSL may re-rank the highest ranked prompt against the combined top-tier prompts (608). The top output of the re-ranking is then assigned as the representative prompt for the first field of troubleshooting response.

In unchained operation, a language model, such as an LLM, may be used to linearly question and/or cross-question based on the generated prompt. For example, where linear responses fail a NLP semantic/syntactic reverse validation, a combination of cross-question responses may be used to synthesize a response. In some cases, a failed response may be used to ‘guardrail’ future investigations by the language model. A signature from the failure response may be used to confine the response space of the language model. Thus, failed responses create language space boundaries to avoid generation of repeated responses that fail on the same or similar evaluation criteria.

In chained operation, the representative prompt for the first field may then be used as a starting point type trigger for the prompts for subsequent fields of the troubleshooting response. In other words, the PSL 600 may use the selected representative prompt of the first field as a trigger for generation of a second field prompt (610), effectively chaining the prompt generation process.

The PSL 600 proceeds with generation of the second prompt with candidate generation (602), ranking (604), top-tier selection/combination (606), and re-ranking (608). The second representative prompt second for the second field is then used as a trigger for a third field prompt, repeating until each field is a assigned a representative prompt. The chaining process may facilitate internal consistency among the fields resulting from the prompts.

The prompts may be used to query the LLM to obtain field text for each field (612). The language model may compare and select among linear responses based on usability and accuracy. The language model may ‘ask’ targeted questions (using the determined prompts) to retrieve information relevant to the fields. The prompts and/or field text may be reverse validated by the PSL 600 using NLP metrics to ensure that the final generated troubleshooting response maintain internal coherence and external consistency with existing documented troubleshooting responses for the power generation device.

The methods, devices, processing, and logic described in the various sections above may be implemented in many different ways and in many different combinations of hardware and software. For example, all or parts of the implementations may be circuitry that includes an instruction processor, such as a Central Processing Unit (CPU), microcontroller, or a microprocessor; an Application Specific Integrated Circuit (ASIC), Programmable Logic Device (PLD), or Field Programmable Gate Array (FPGA); or circuitry that includes discrete logic or other circuit components, including analog circuit components, digital circuit components or both; or any combination thereof. The circuitry may include discrete interconnected hardware components and/or may be combined on a single integrated circuit die, distributed among multiple integrated circuit dies, or implemented in a Multiple Chip Module (MCM) of multiple integrated circuit dies in a common package, as examples.

The circuitry may further include or access instructions for execution by the circuitry. The instructions may be embodied as a signal and/or data stream and/or may be stored in a tangible storage medium that is other than a transitory signal, such as a flash memory, a Random Access Memory (RAM), a Read Only Memory (ROM), an Erasable Programmable Read Only Memory (EPROM); or on a magnetic or optical disc, such as a Compact Disc Read Only Memory (CDROM), Hard Disk Drive (HDD), or other magnetic or optical disk; or in or on another machine-readable medium. A product, such as a computer program product, may particularly include a storage medium and instructions stored in or on the medium, and the instructions when executed by the circuitry in a device may cause the device to implement any of the processing described above or illustrated in the drawings.

The implementations may be distributed as circuitry, e.g., hardware, and/or a combination of hardware and software among multiple system components, such as among multiple processors and memories, optionally including multiple distributed processing systems. Parameters, databases, and other data structures may be separately stored and managed, may be incorporated into a single memory or database, may be logically and physically organized in many different ways, and may be implemented in many different ways, including as data structures such as linked lists, hash tables, arrays, records, objects, or implicit storage mechanisms. Programs may be parts (e.g., subroutines) of a single program, separate programs, distributed across several memories and processors, or implemented in many different ways, such as in a library, such as a shared library (e.g., a Dynamic Link Library (DLL)). The DLL, for example, may store instructions that perform any of the processing described above or illustrated in the drawings, when executed by the circuitry.

Various implementations have been specifically described. However, many other implementations are also possible.

Table 1 includes various examples.

TABLE 1
Examples

1. A method including:
at troubleshooting response synthesis circuitry:
determining a current condition is present at a first power generation device with a first
power generation device type;
predicting, using a power generation device fault model and historical data
particularized to the first power generation device, a fault stack and a predicted fault
identifier for the first power generation device type, based on the current condition;
accessing a datastore of troubleshooting documentation for at least a second power
generation device type different from the first power generation device type;
applying language processing to the datastore of troubleshooting documentation to
determine a documented troubleshooting response associated with at least a
documented fault identifier for the second power generation device type;
determining, using the language processing and based on the predicted fault identifier
and/or the fault stack, that the documented fault identifier for the second power
generation device type corresponds to the predicted fault identifier for the first power
generation device type;
applying generative language processing using the documented troubleshooting
response to generate a synthesized troubleshooting response including a natural
language description of an action particularized to at least the first power generation
device type; and
generating a troubleshooting message including the synthesized troubleshooting
response; and
sending, via network interface circuitry, the troubleshooting message to an operator associated
with the first power generation device.
2. The method of example 1 or any other example in this table, where the current
condition and/or the fault stack include time series data.
3. The method of example 1 or any other example in this table, where the documented
fault identifier and/or the predicted fault identifier include a fault code.
4. The method of example 1 or any other example in this table, where:
determining that the documented fault identifier for the second power generation device type
corresponds to the predicted fault identifier for the first power generation device type
includes determining a similarity between a first description associated with the predicted
fault identifier and a second description associated with the documented fault identifier; and
the first description, the second description, or both being present within the datastore.
5. The method of example 4 or any other example in this table, where the first
description, the second description, or both include a natural language description.
6. The method of example 1 or any other example in this table, further including
determining, before determining that the documented fault identifier for the second power
generation device type corresponds to the predicted fault identifier for the first power
generation device type, that a corresponding troubleshooting response for the predicted fault
identifier is not present within the datastore.
7. The method of example 1 or any other example in this table, where determining that
the documented fault identifier for the second power generation device type corresponds to
the predicted fault identifier for the first power generation device type includes determining a
similarity between the fault stack and a second description associated with the documented
fault identifier.
8. The method of example 1 or any other example in this table, further including
determining that the historical data is particularized to the first power generation device
includes determining a coherence value between the first power generation device and a
second power generation device of the second power generation device type.
9. The method of example 8 or any other example in this table, where the coherence
value is derived from power generation device performance history of the first and second
power generation device, demand planning for the first and second power generation device,
and/or consumption during multiple selected time windows for the first and second power
generation device.
10. The method of example 1 or any other example in this table, further including sending
the troubleshooting message to a logger database associated with the first power generation
device, where the troubleshooting message includes an alert message for the operator and/or
a detailed troubleshooting report for the operator.
11. The method of example 1 or any other example in this table, where the detailed
troubleshooting report includes a natural language description of at least multiple
troubleshooting steps including the action particularized to at least the first power generation
device type.
12. The method of example 1 or any other example in this table, where the action
particularized to at least the first power generation device type includes:
a transformation of an action described within the documented troubleshooting
response into an action using first instrumentation available for the first power
generation device type and unavailable on the second power generation device type;
a transformation of an action described within the documented troubleshooting
response into an action using the same instrumentation at different locations for the
first and second power generation device types;
a transformation of an action described within the documented troubleshooting
response into an action the same instrumentation with different labeling for the first
and second power generation device types; and/or
a translation of a description of action described within the documented
troubleshooting response into a different language.
13. Non-transitory machine-readable media configured to store instructions thereon, the
instructions configured to, when executed, cause a machine to:
determine a current condition is present at a first power generation device with a first
power generation device type;
predict, using a power generation device fault model and historical data particularized
to the first power generation device, a fault stack and a predicted fault identifier for
the first power generation device type, based on the current condition;
access a datastore of troubleshooting documentation for at least a second power
generation device type different from the first power generation device type;
apply language processing to the datastore of troubleshooting documentation to
determine a documented troubleshooting response associated with at least a
documented fault identifier for the second power generation device type;
determine, using the language processing and based on the predicted fault identifier
and/or the fault stack, that the documented fault identifier for the second power
generation device type corresponds to the predicted fault identifier for the first power
generation device type;
apply generative language processing using the documented troubleshooting response
to generate a synthesized troubleshooting response including a natural language
description of an action particularized to at least the first power generation device
type;
generate a troubleshooting message including the synthesized troubleshooting
response; and
send the troubleshooting message to an operator associated with the first power
generation device.
14. The non-transitory machine-readable media of example 13 or any other example in this
table, where the current condition and/or the fault stack include time series data.
15. The non-transitory machine-readable media of example 13 or any other example in this
table, where the documented fault identifier and/or the predicted fault identifier include a
fault code.
16. The non-transitory machine-readable media of example 13 or any other example in this
table, where:
the instructions are further configured to cause the machine to determine that the documented
fault identifier for the second power generation device type corresponds to the predicted fault
identifier for the first power generation device type by determining a similarity between a
first description associated with the predicted fault identifier and a second description
associated with the documented fault identifier; and
the first description, the second description, or both being present within the datastore.
17. The non-transitory machine-readable media of example 14 or any other example in this
table, where the first description, the second description, or both include a natural language
description.
18. The non-transitory machine-readable media of example 13 or any other example in this
table,, the instructions are further configured to cause the machine to determine, before
determining that the documented fault identifier for the second power generation device type
corresponds to the predicted fault identifier for the first power generation device type, that a
corresponding troubleshooting response for the predicted fault identifier is not present within
the datastore.
19. A system including:
troubleshooting response synthesis circuitry configured to:
determine a current condition is present at a first power generation device with a first
power generation device type;
predict, using a power generation device fault model and historical data particularized
to the first power generation device, a fault stack and a predicted fault identifier for
the first power generation device type, based on the current condition;
access a datastore of troubleshooting documentation for at least a second power
generation device type different from the first power generation device type;
apply language processing to the datastore of troubleshooting documentation to
determine a documented troubleshooting response associated with at least a
documented fault identifier for the second power generation device type;
determine, using the language processing and based on the predicted fault identifier
and/or the fault stack, that the documented fault identifier for the second power
generation device type corresponds to the predicted fault identifier for the first power
generation device type;
apply generative language processing using the documented troubleshooting response
to generate a synthesized troubleshooting response including a natural language
description of an action particularized to at least the first power generation device
type; and
generate a troubleshooting message including the synthesized troubleshooting
response; and
network interface circuitry configured to send the troubleshooting message to an operator
associated with the first power generation device.
20. The system of example 19 or any other example in this table, where the
troubleshooting response synthesis circuitry is configured to determine that the historical
data is particularized to the first power generation device by determining a coherence value
between the first power generation device and a second power generation device of the
second power generation device type.
21. A system including circuitry configured to implement any feature or any combination
of features described in this table or disclosure.
22. A method including implementing any feature or any combination of features
described in this table or disclosure.
23. A method including installing the system of any example in this table.
24. A product including:
machine-readable media; and
instructions stored on the machine-readable media, the instructions configured to cause a
processor to perform (at least in part) the method of any example in this table, where:
optionally, the machine-readable media is non-transitory;
optionally, the machine-readable media is other than a transitory signal; and
optionally, the instructions are executable.
25. A method including:
responsive to a first fault identifier, determining that a documented fault description for the
first fault identifier is not present within a datastore of troubleshooting documentation for a
first power generation device;
after determining that the documented fault description is not present within the datastore:
ranking, based on fault descriptions associated with the power generation device for fault
identifiers other than first fault identifier, multiple candidate fault descriptions associated
with one or more second fault identifiers different from the first fault identifier;
selecting from the multiple candidate fault descriptions, a highest-ranked candidate fault
description and multiple top-tier candidate fault descriptions other than the highest-ranked
candidate fault description;
combining the multiple top-tier candidate fault descriptions to form a synthetic candidate fault
description;
re-ranking the highest-ranked candidate fault description in view of the synthetic candidate
fault description; and
based on the re-ranking, determining which of the highest-ranked candidate fault description
and the synthetic candidate fault description to associate with the first fault identifier.
26. The method of example 25 or any other example in this table, where the ranking
includes a natural language processing (NLP) similarity analysis between the multiple
candidate fault descriptions and one or more proxy descriptions for the first fault identifier.
27. The method of example 26 or any other example in this table, where the similarity
analysis includes assigning a lift score to each of the multiple candidate fault descriptions.
28. The method of example 26 or any other example in this table, where the proxy
descriptions include one or more descriptions associated with fault identifiers for the first
power generation device other than the first fault identifier.
29. The method of example 25 or any other example in this table, where the one or more
second fault identifiers include fault identifiers for a second power generation device
different than the first power generation device.
30. The method of example 25 or any other example in this table, where the fault identifier
includes a fault code.
31. The method of example 25 or any other example in this table, where a count of the
multiple top-tier candidate fault descriptions is determined based on:
a default number;
a threshold similarity to from and one or more proxy descriptions for the first fault identifier;
a minimum count of the multiple top-tier candidate fault descriptions;
a maximum count of the multiple top-tier candidate fault descriptions; and/or
a user-designated value.
32. The method of example 25 or any other example in this table, where selecting the
multiple candidate fault descriptions for ranking includes applying a language model to the
datastore of troubleshooting documentation to identify candidate descriptions.
33. A method of generating a synthetic text for a troubleshooting response for a fault
including:
for each of multiple first candidate prompts for a first field of the troubleshooting response:
selecting, via a large language model and from a fault description for the fault, one or
more words for the candidate prompt; and
analyzing the candidate prompt to determine a similarity to the fault description and/or
one or more existing proxy descriptions to obtain a ranking for the candidate prompt
among the multiple candidate prompts;
selecting from among multiple first candidate prompts highest-ranked candidate prompt; and
executing, via the large language model, a chained selection of multiple second candidate
prompts for a second field of the using the highest-ranked candidate prompt as a trigger,
where:
chaining selection of prompts for multiple fields of a troubleshooting response enforces
coherence among prompt responses for the troubleshooting response.
34. The method of example 33 or any other example in this table, where the chained
selection of prompts extends to each synthetically generated field of the troubleshooting
response.
35. The method of example 33 or any other example in this table, where analyzing the
candidate prompt includes applying natural language processing (NLP) to determine the
similarity.
36. The method of example 35 or any other example in this table, where an entropy score
is assigned via the NLP to indicate the similarity.

Headings and/or subheadings used herein are intended only to aid the reader with understanding described implementations. The invention is defined by the claims.

What is claimed is:

1. A method including:
at troubleshooting response synthesis circuitry:
determining a current condition is present at a first power generation device with a first power generation device type;
predicting, using a power generation device fault model and historical data particularized to the first power generation device, a fault stack and a predicted fault identifier for the first power generation device type, based on the current condition;
accessing a datastore of troubleshooting documentation for at least a second power generation device type different from the first power generation device type;
applying language processing to the datastore of troubleshooting documentation to determine a documented troubleshooting response associated with at least a documented fault identifier for the second power generation device type;
determining, using the language processing and based on the predicted fault identifier and/or the fault stack, that the documented fault identifier for the second power generation device type corresponds to the predicted fault identifier for the first power generation device type;
applying generative language processing using the documented troubleshooting response to generate a synthesized troubleshooting response including a natural language description of an action particularized to at least the first power generation device type; and
generating a troubleshooting message including the synthesized troubleshooting response; and
sending, via network interface circuitry, the troubleshooting message to an operator associated with the first power generation device.

2. The method of claim 1, where the current condition and/or the fault stack include time series data.

3. The method of claim 1, where the documented fault identifier and/or the predicted fault identifier include a fault code.

4. The method of claim 1, where:
determining that the documented fault identifier for the second power generation device type corresponds to the predicted fault identifier for the first power generation device type includes determining a similarity between a first description associated with the predicted fault identifier and a second description associated with the documented fault identifier; and
the first description, the second description, or both being present within the datastore.

5. The method of claim 4, where the first description, the second description, or both include a natural language description.

6. The method of claim 1, further including determining, before determining that the documented fault identifier for the second power generation device type corresponds to the predicted fault identifier for the first power generation device type, that a corresponding troubleshooting response for the predicted fault identifier is not present within the datastore.

7. The method of claim 1, where determining that the documented fault identifier for the second power generation device type corresponds to the predicted fault identifier for the first power generation device type includes determining a similarity between the fault stack and a second description associated with the documented fault identifier.

8. The method of claim 1, further including determining that the historical data is particularized to the first power generation device includes determining a coherence value between the first power generation device and a second power generation device.

9. The method of claim 8, where the coherence value is derived from power generation device performance history of the first and second power generation device, demand planning for the first and second power generation device, and/or consumption during multiple selected time windows for the first and second power generation device.

10. The method of claim 1, further including sending the troubleshooting message to a logger database associated with the first power generation device, where the troubleshooting message includes an alert message for the operator and/or a detailed troubleshooting report for the operator.

11. The method of claim 10, where the detailed troubleshooting report includes a natural language description of at least multiple troubleshooting steps including the action particularized to at least the first power generation device type.

12. The method of claim 1, where the action particularized to at least the first power generation device type includes:
a transformation of an action described within the documented troubleshooting response into an action using first instrumentation available for the first power generation device type and unavailable on the second power generation device type;
a transformation of an action described within the documented troubleshooting response into an action using the same instrumentation at different locations for the first and second power generation device types;
a transformation of an action described within the documented troubleshooting response into an action the same instrumentation with different labeling for the first and second power generation device types; and/or
a translation of a description of action described within the documented troubleshooting response into a different language.

13. Non-transitory machine-readable media configured to store instructions thereon, the instructions configured to, when executed, cause a machine to:
determine a current condition is present at a first power generation device with a first power generation device type;
predict, using a power generation device fault model and historical data particularized to the first power generation device, a fault stack and a predicted fault identifier for the first power generation device type, based on the current condition;
access a datastore of troubleshooting documentation for at least a second power generation device type different from the first power generation device type;
apply language processing to the datastore of troubleshooting documentation to determine a documented troubleshooting response associated with at least a documented fault identifier for the second power generation device type;
determine, using the language processing and based on the predicted fault identifier and/or the fault stack, that the documented fault identifier for the second power generation device type corresponds to the predicted fault identifier for the first power generation device type;
apply generative language processing using the documented troubleshooting response to generate a synthesized troubleshooting response including a natural language description of an action particularized to at least the first power generation device type; and
generate a troubleshooting message including the synthesized troubleshooting response; and
send, via network interface circuitry, the troubleshooting message to an operator associated with the first power generation device.

14. The non-transitory machine-readable media of claim 13, where the current condition and/or the fault stack include time series data.

15. The non-transitory machine-readable media of claim 13, where the documented fault identifier and/or the predicted fault identifier include a fault code.

16. The non-transitory machine-readable media of claim 13, where:
the instructions are further configured to cause the machine to determine that the documented fault identifier for the second power generation device type corresponds to the predicted fault identifier for the first power generation device type by determining a similarity between a first description associated with the predicted fault identifier and a second description associated with the documented fault identifier; and
the first description, the second description, or both being present within the datastore.

17. The non-transitory machine-readable media of claim 16, where the first description, the second description, or both include a natural language description.

18. The non-transitory machine-readable media of claim 13, the instructions are further configured to cause the machine to determine, before determining that the documented fault identifier for the second power generation device type corresponds to the predicted fault identifier for the first power generation device type, that a corresponding troubleshooting response for the predicted fault identifier is not present within the datastore.

19. A system including:
troubleshooting response synthesis circuitry configured to:
determine a current condition is present at a first power generation device with a first power generation device type;
predict, using a power generation device fault model and historical data particularized to the first power generation device, a fault stack and a predicted fault identifier for the first power generation device type, based on the current condition;
access a datastore of troubleshooting documentation for at least a second power generation device type different from the first power generation device type;
apply language processing to the datastore of troubleshooting documentation to determine a documented troubleshooting response associated with at least a documented fault identifier for the second power generation device type;
determine, using the language processing and based on the predicted fault identifier and/or the fault stack, that the documented fault identifier for the second power generation device type corresponds to the predicted fault identifier for the first power generation device type;
apply generative language processing using the documented troubleshooting response to generate a synthesized troubleshooting response including a natural language description of an action particularized to at least the first power generation device type; and
generate a troubleshooting message including the synthesized troubleshooting response; and
network interface circuitry configured to send the troubleshooting message to an operator associated with the first power generation device.

20. The system of claim 19, where the troubleshooting response synthesis circuitry is configured to determine that the historical data is particularized to the first power generation device by determining a coherence value between the first power generation device and a second power generation device.

21. A method including:
responsive to a first fault identifier, determining that a documented fault description for the first fault identifier is not present within a datastore of troubleshooting documentation for a first power generation device;
after determining that the documented fault description is not present within the datastore: ranking, based on fault descriptions associated with the power generation device for fault identifiers other than first fault identifier, multiple candidate fault descriptions associated with one or more second fault identifiers different from the first fault identifier;
selecting from the multiple candidate fault descriptions, a highest-ranked candidate fault description and multiple top-tier candidate fault descriptions other than the highest-ranked candidate fault description;
combining the multiple top-tier candidate fault descriptions to form a synthetic candidate fault description;
re-ranking the highest-ranked candidate fault description in view of the synthetic candidate fault description; and
based on the re-ranking, determining which of the highest-ranked candidate fault description and the synthetic candidate fault description to associate with the first fault identifier.

22. The method of claim 21, where the ranking includes a natural language processing (NLP) similarity analysis between the multiple candidate fault descriptions and one or more proxy descriptions for the first fault identifier.

23. The method of claim 22, where the similarity analysis includes assigning a lift score to each of the multiple candidate fault descriptions.

24. The method of claim 22, where the proxy descriptions include one or more descriptions associated with fault identifiers for the first power generation device other than the first fault identifier.

25. The method of claim 21, where the one or more second fault identifiers include fault identifiers for a second power generation device different than the first power generation device.

26. The method of claim 21, where the fault identifier includes a fault code.

27. The method of claim 21, where a count of the multiple top-tier candidate fault descriptions is determined based on:
a default number;
a threshold similarity to from and one or more proxy descriptions for the first fault identifier;
a minimum count of the multiple top-tier candidate fault descriptions;
a maximum count of the multiple top-tier candidate fault descriptions; and/or
a user-designated value.

28. The method of claim 21, where selecting the multiple candidate fault descriptions for ranking includes applying a language model to the datastore of troubleshooting documentation to identify candidate descriptions.

29. A method of generating a synthetic text for a troubleshooting response for a fault including:
for each of multiple first candidate prompts for a first field of the troubleshooting response:
selecting, via a large language model and from a fault description for the fault, one or more words for the candidate prompt; and
analyzing the candidate prompt to determine a similarity to the fault description and/or one or more existing proxy descriptions to obtain a ranking for the candidate prompt among the multiple candidate prompts;
selecting from among multiple first candidate prompts highest-ranked candidate prompt; and
executing, via the large language model, a chained selection of multiple second candidate prompts for a second field of the troubleshooting response using the highest-ranked candidate prompt as a trigger, where:
chaining selection of prompts for multiple fields of the troubleshooting response enforces coherence among prompt responses for the troubleshooting response.

30. The method of claim 29, where the chained selection of prompts extends to each synthetically generated field of the troubleshooting response.

31. The method of claim 29, where analyzing the candidate prompt includes applying natural language processing (NLP) to determine the similarity.

32. The method of claim 31, where an entropy score is assigned via the NLP to indicate the similarity.
